(19) United States
(12) Patent Application Publication
(10) Pub. No.: US 2009/0263525 A1
(43) Pub. Date: Oct. 22, 2009

(54) APPARATUS FOR MANUFACTURING LIQUID SILICON FOAM IN THE FORM OF ROLL

(76) Inventor: Dong-Yun Kim, Incheon (KR)

Correspondence Address: ROBERT W. J. USHER;PATENT AGENT, 1133 BROADWAY, #1515, NEW YORK, NY, 10010, US

(21) Appl. No.: 12/520,599

(22) PCT Filed: Dec. 27, 2007
(86) PCT No.: PCT/KR2007/006861

§ 371 Date: Jun. 22, 2009

(30) Foreign Application Priority Data
Dec. 29, 2006 (KR) 1020060138210

(51) Int. Cl. B28B 1/10

(52) U.S. Cl. 425/89

(57) ABSTRACT

The present invention relates to an apparatus for manufacturing a roll-type liquid silicone rubber foam having no surface viscosity and a thin film shape with a greatly reduced thickness of 0.2 mm, which is capable of manufacturing a roll-type liquid silicone rubber foam having a predetermined width (300 mm-1,000 mm) in a continuous process useful for mass production. The apparatus includes a first PET film-supplying unit, adapted to supply a first PET film having a predetermined width; a liquid silicone rubber-supplying unit, adapted to apply a liquid silicone rubber containing a foaming agent and a curing agent on a surface of the PET film, which is supplied from the first PET film-supplying unit; a second PET film-supplying unit, adapted to supply a second PET film having no stickiness on the liquid silicone rubber applied to the first PET film, which is transferred from the first PET film-supplying unit through the liquid silicone rubber-supplying unit; a second PET film-recovering unit, adapted to recover the second PET film transferred from the second PET film-supplying unit; a foaming and curing unit, positioned between the second PET film-supplying unit and the second PET film-recovering unit and adapted to foam and cure the liquid silicone rubber disposed between the first PET film and the second PET film and to control a thickness of the liquid silicone rubber which is being foamed; and a liquid silicone rubber foam-take-up unit, adapted to take up the liquid silicone rubber foam as the final product into a roll form, which is transferred from the foaming and curing unit during the recovery of the second PET film into the second PET film-recovering unit.

### TECHNICAL FIELD

The present invention relates to an apparatus for manufacturing a liquid silicone rubber (LSR) foam, and, more particularly, to an apparatus for manufacturing a roll-type liquid silicone rubber foam having no surface viscosity and a thin film shape with a greatly reduced thickness of 0.2 mm, which is capable of manufacturing a roll-type liquid silicone rubber foam having a predetermined width (300 mm-1,000 mm) in a continuous process useful for mass production.

### BACKGROUND ART

In recent years, electronic items such as miniaturized mobile telephones and electronic devices typically include therein essential parts, for example, an LCD (Liquid Crystal Display), a vibrating motor and a speaker, which are provided with impact-absorbing (damping) material attached thereto to protect the products from impacts.

These days, various products are used as the impact-absorbing material, and urethane-based foams are predominantly used among the products.

Although urethane-based foam is excellent in impact absorption, it is problematic in that the impact-absorbing capacity and heat resistance are decreased compared to the original performance after use for an extended period of time.

As a product intended to compensate for the defects of the urethane-based foam, a silicone foam is proposed.

In conventional silicone foams, a molded foam, which is manufactured using a mold, an extruded foam, which is manufactured using an extruder, and other various foamed sheets are disclosed, although there has been no foam product that has a thickness corresponding to thin film and can be manufactured in a roll-type form on a massive scale through a continuous process.

In the prior art, there are silicone foam products, which are manufactured by adding foaming agent and curing agent to silicone rubber and extruding the mixture using an extruder, and sheet-shaped foam products, which are manufactured by passing a silicone sheet through a heating device to cause the silicone sheet to foam due to the foaming agent.

However, such conventional manufacturing methods have disadvantages in that it is difficult to manufacture the foam products on a massive scale because the foam product is manufactured into a sheet form, the silicone foam products inevitably have fine pores formed therein due to the foaming action, the foam product cannot be manufactured into a thin film form having a greatly reduced thickness of 0.2 mm in consideration of its normal thickness of 10 mm or more, and a foam product having a large width (300 mm-1,000 mm) cannot be manufactured.

### DISCLOSURE OF INVENTION

### Technical Problem

Accordingly, the present invention has been made keeping in mind the above problems occurring in the prior art, and an object of the present invention is to provide an apparatus for manufacturing a roll-type liquid silicone rubber foam which has no viscosity, a predetermined width (300 mm-1,000 mm), and a thickness (0.2 mm) as small as that of a thin film, and which can be used as impact-absorbing (relaxing) agent for LCDs (Liquid Crystal Display), vibrating motors, speakers and the like, which are essential components of electronic products.

Another object of the present invention is to provide an apparatus for manufacturing a roll-type liquid silicone rubber foam, which is capable of manufacturing a roll-type liquid silicone rubber foam having a greatly reduced thickness (0.2 mm) and a predetermined width (300 mm-1,000 mm) through a continuous process for mass production.

### Technical Solution

In order to accomplish the above object, the present invention provides an apparatus for manufacturing a liquid silicone rubber foam, including: a first PET film-supplying unit, adapted to supply a first PET film having a predetermined width; a liquid silicone rubber-supplying unit, adapted to apply a liquid silicone rubber, containing a foaming agent and a curing agent, on a surface of the PET film, which is supplied from the first PET film-supplying unit; a second PET film-supplying unit, adapted to supply a second PET film having no stickiness on the liquid silicone rubber applied to the first PET film which is transferred from the first PET film-supplying unit through the liquid silicone rubber-supplying unit; a second PET film-recovering unit, adapted to recover the second PET film transferred from the second PET film-supplying unit; a foaming and curing unit, positioned between the second PET film-supplying unit and the second PET film-recovering unit and adapted to foam and cure the liquid silicone rubber disposed between the first PET film and the second PET film and to control a thickness of the liquid silicone rubber which is being foamed; and a liquid silicone rubber foam-take-up unit, adapted to take up the liquid silicone rubber foam, as a final product, in a form of a roll, which is transferred from the foaming and curing unit during the recovering the second PET film into the second PET film-recovering unit.

In another aspect, the present invention provides an apparatus for manufacturing a liquid silicone rubber foam, comprising: a first PET film-supplying unit adapted to supply a first PET film having a predetermined width; a liquid silicone rubber-supplying unit adapted to apply a liquid silicone rubber, containing a foaming agent and a curing agent, on a surface of the PET film, which is supplied from the first PET film-supplying unit; a second PET film-circulating unit, adapted to supply a second PET film having no stickiness on the liquid silicone rubber applied to the first PET film, which is supplied from the first PET film-supplying unit through the liquid silicone rubber-supplying unit, and adapted to circulate the second PET film through a foaming and curing unit and a plurality of rollers; a foaming and curing unit, adapted to foam and cure the liquid silicone rubber disposed between the first PET film and the second PET film and to control a thickness of the liquid silicone rubber; and a liquid silicone rubber foam-take-up unit, adapted to take up the liquid silicone rubber foam, as a final product, into a form of a roll, which is transferred from the foaming and curing unit during the circulating the second PET film.

### ADVANTAGEOUS EFFECTS

As describe above, the present invention has advantages in that the liquid silicone rubber foam manufactured by the present invention has no viscosity, a predetermined width (300 mm-1,000 mm) and a thickness (0.2 mm) corresponding to a thin film, and can be used as impact-absorbing (relaxing) agent for LCDs (Liquid Crystal Display), vibrating motors, speakers and the like, which are essential components of electronic products.

Further, the present invention has advantages in that the apparatus according to the present invention is capable of manufacturing a roll-type liquid silicone rubber foam having a greatly reduced thickness (0.2 mm) and a predetermined width (300 mm-1,000 mm) through a continuous process useful for mass production.

### BRIEF DESCRIPTION OF THE DRAWINGS

FIG. 1 is a schematic view showing an apparatus for manufacturing a roll-type liquid silicone rubber foam, according to a first embodiment of the present invention;

FIG. 2 is a detailed view showing a foaming and curing unit according to the present invention;

FIG. 3 is an enlarged view illustrating functions of substantial parts of the foaming and curing unit according to the present invention;

FIG. 4 is a view of a liquid silicone rubber foam according to the present invention;

FIG. 5 is a cross-sectional view of a second PET film according to the present invention;

FIG. 6 is a cross-sectional view of a liquid silicone rubber foam and a second PET film, which are combined with each other, according to the present invention;

FIG. 7 is a schematic view showing an apparatus for manufacturing a roll-type liquid silicone rubber foam, according to a second embodiment of the present invention; and

FIG. 8 is a schematic view showing an apparatus for manufacturing a roll-type liquid silicone rubber foam, according to a third embodiment of the present invention.

### DESCRIPTION OF REFERENCE NUMERALS OF SUBSTANTIAL PARTS

10: first PET film-supplying unit
11: supply roller
12: first PET film
20: liquid silicone rubber-supplying unit
21: guide part
22: liquid silicone rubber
23: feed rate-controlling part
24: base part
30: second PET film-supplying unit
31: supply roller
32: second PET film
40: second PET film-recovering unit
41: recovery roller
50: foaming and curing unit
51: foaming and curing chamber
52: thickness-controlling and pressing bar
53: support bar
52a: inclined surface
54: heater part
55: upper thickness-controlling and pressing roller
56: lower support roller
60: liquid silicone rubber foam-recovering unit
61: take-up roller
G: liquid silicone rubber foam
70: second PET film-circulating unit
71, 72, 73: rollers

### BEST MODE FOR CARRYING OUT THE INVENTION

Preferred embodiments of the present invention will be described in further detail with reference to the accompanying drawings.

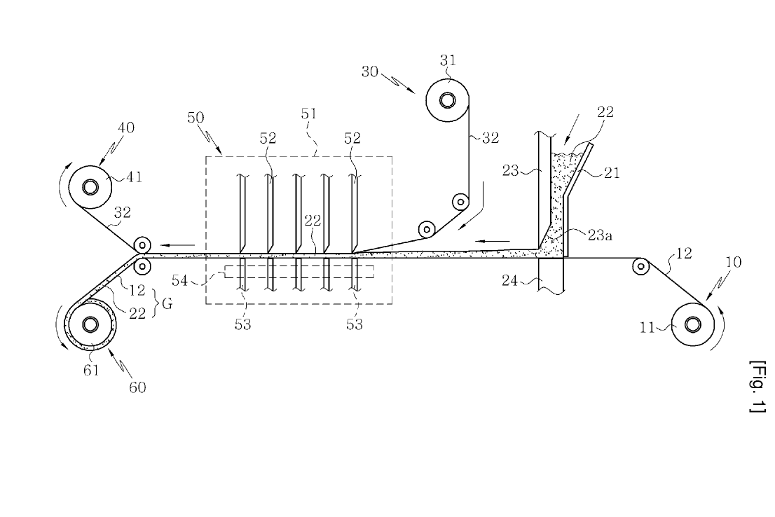

FIG. 1 is a schematic view showing an apparatus for manufacturing a roll-type liquid silicone rubber foam according to a first embodiment of the present invention.

As shown in the drawing, the apparatus for manufacturing a roll-type liquid silicone rubber foam according to a first embodiment of the present invention comprises: a first PET film-supplying unit 10, adapted to supply a first PET (Polyethylene terephthalate resin) film 12, a liquid silicone rubber-supplying unit 20, adapted to apply liquid silicone rubber 22 containing a foaming agent and a curing agent on the surface of the PET film 12 which is supplied from the first PET film-supplying unit 10, a second PET film-supplying unit 30, adapted to supply a second PET film 32 having no stickiness on the liquid silicone rubber 22 applied to the first PET film 12 which is transferred from the first PET film-supplying unit 10 through the liquid silicone rubber-supplying unit 20, a second PET film-recovering unit 40, adapted to recover the second PET film 32 transferred from the second PET film-supplying unit 30, a foaming and curing unit 50, positioned between the second PET film-supplying unit 30 and the second PET film-recovering unit 40 and adapted to foam and cure the liquid silicone rubber 22 disposed between the first PET film 12 and the second PET film 32 and to control the thickness of the liquid silicone rubber 22 that is being foamed, and a liquid silicone rubber foam-take-up unit 60, adapted to take up the liquid silicone rubber foam G as the final product into a roll form, which is transferred from the foaming and curing unit 50 during the recovery of the second PET film 32 into the second PET film-recovering unit 40.

The first PET film-supplying unit 10 functions to supply the first PET film 12, wound around a supply roller 11 and having a predetermined width, to the liquid silicone rubber-supplying unit 20, in which is preferable that the first PET film have a width of 300 mm-1,000 mm.

The liquid silicone rubber-supplying unit 20 comprises a guide part 21, into which the liquid silicone rubber 22 is introduced, a feed rate-controlling part 23, to allow the liquid silicone rubber 22 introduced through the guide part 21 to be distributed to the first PET film 12 at a predetermined feed rate, and a base part 24, installed opposite the feed rate-controlling part 23.

In this regard, the liquid silicone rubber 22 is thermosetting liquid silicone rubber, and contains a foaming agent and a curing agent, which are mixed with each other at a predetermined mixing ratio.

The feed rate-controlling part 23 is constructed to be vertically displaceable so as to control the amount of liquid silicone rubber 22 distributed on the first PET film 12, and is provided at the lower end with an inclined surface 23a to assure easy distribution of the liquid silicone rubber 22.

The second PET film-supplying unit 30 is configured to have the same width as that of the first PET film 12, and functions to cause the second PET film 32, which is supplied from a supply roller 31 and is a releasable film having no stickiness, to come into contact with the upper surface of the liquid silicone rubber 22 supplied from the liquid silicone rubber-supplying unit 20. The second PET film 32 will pass through the foaming and curing unit 50 and pass to the second PET film-recovering unit 40, where it is recovered.

The second PET film-recovering unit 40 functions to take up the second PET film 32, passed through the foaming and curing unit 50, around a recovery roller 41.

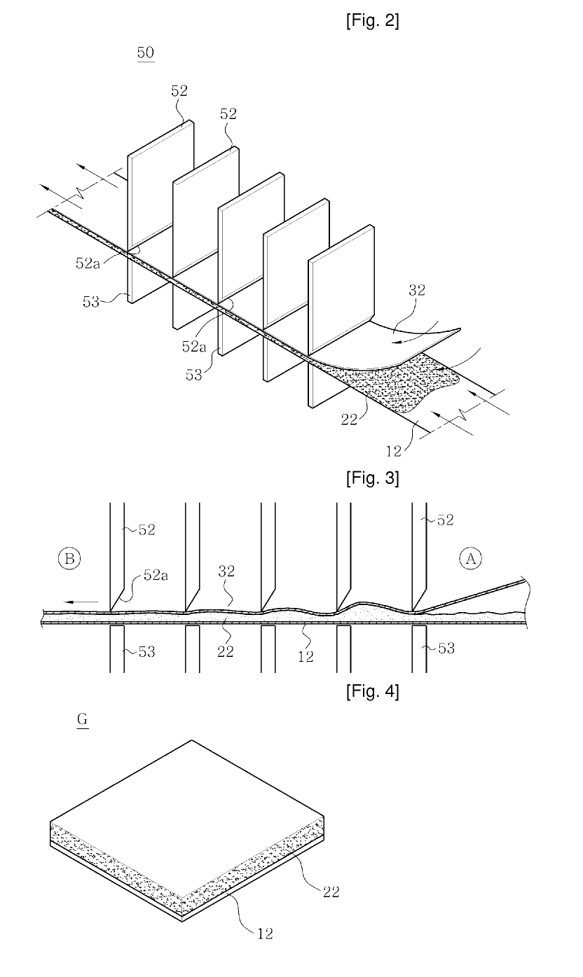

The foaming and curing unit 50 comprises a foaming and curing chamber 51, which is configured to have a case shape, a plurality of thickness-controlling and pressing bars 52 disposed in the foaming and curing chamber 51, which is positioned over the second PET film 32 and is vertically displaceable so as to control the thickness of the liquid silicone rubber 22 disposed between the first PET film 12 and the second PET film 32, and in which the plurality of thickness-controlling and pressing bars 52 is positioned at predetermined intervals, as shown in FIG. 2, a plurality of support bars 53, which are positioned under the first PET film 12 and aligned with the thickness-controlling and pressing bars 52, and a heater part 54, which is installed in the foaming and curing chamber 51 to promote the foaming and curing of the liquid silicone rubber 22.

Each of the plurality of thickness-controlling and pressing bars 52 is provided at a lower end thereof with an inclined surface 52a having a predetermined angle to allow the efficient pressing action.

Although this is not shown in the drawings, a table (not shown), on which the first PET film 12, the liquid silicone rubber 22 and the second PET film 32 are transferred, is provided on both lateral sides thereof with side walls, so that the first PET film 12, the liquid silicone rubber 22 and the second PET film 32 do not deviate from their normal positions, and the liquid silicone rubber 22 does not leak therefrom.

The operation conducted in the foaming and curing unit 50 is described in further detail with reference to FIG. 3.

As shown in the drawing, the first PET film 12, which is supplied from the first PET film-supplying unit 10, is adhered to the liquid silicone rubber 22 distributed from the liquid silicone rubber-supplying unit 20, and is then passed to the foaming and curing unit 50.

At this point, the second PET film 32 from the second PET film-supplying unit 30 is provided on the liquid silicone rubber 22. The second PET film 32 is a film from which stickiness is removed, and thus does not adhere to the liquid silicone rubber 22.

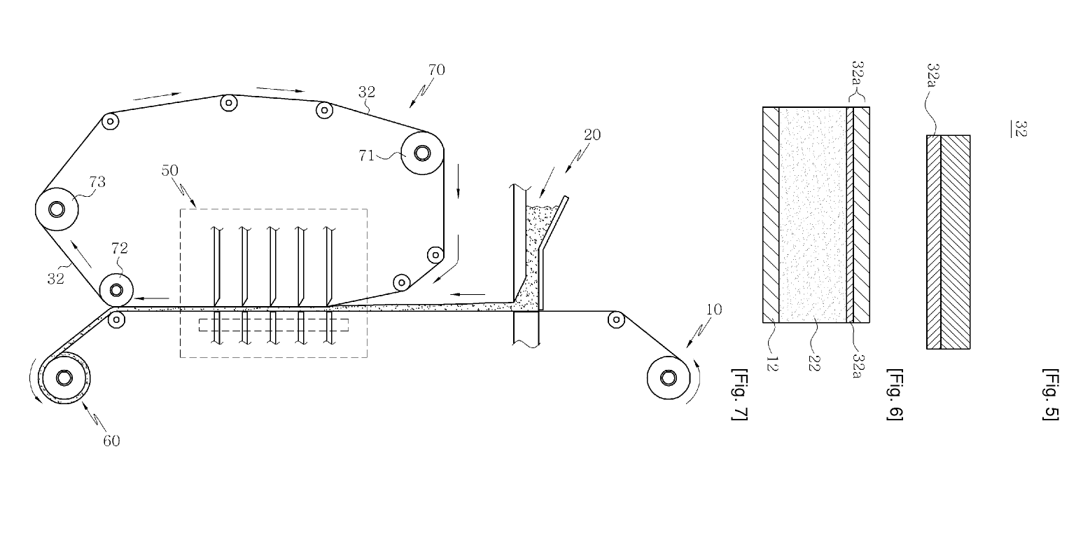

In this case, the second PET film 32 may be one made of material having no stickiness by itself, or may be one which includes a non-sticky layer 32a on only one side, which is brought into contact with the liquid silicone rubber 22, as shown in FIG. 5. The second PET film may be designed to have any other configuration, if desired.

As the first PET film 12, the second PET film 32 and the liquid silicone rubber 22 disposed therebetween, which are arranged as illustrated in FIG. 6, enter the foaming and curing chamber 51 of the foaming and curing unit 50, they move toward position (B) from position (A) of the chamber 51.

During this time, owing to the heating action of the heater part 54 provided in the foaming and curing chamber 51, the liquid silicone rubber 22, which is disposed between the first PET film 12 and the second PET film 32, is foamed and then cured.

More specifically, as the liquid silicone rubber 22 is foamed, its volume is expanded. At this time, since the liquid silicone rubber 22 pressed by the thickness-controlling and pressing bars 52 via the second PET film 32, the liquid silicone rubber 22 is foamed and shaped to have a thickness corresponding to the gaps between the thickness-controlling and pressing bars 52 and the support bars 53 as it proceeds toward position (B) from position (A).

According to the present invention, with the aid of the thickness-controlling and pressing bars 52 of the foaming and curing unit 50, a thin film-shaped silicone foam having a greatly reduced thickness of 0.2 mm can be manufactured. In addition, since the liquid silicone rubber 22 is covered thereon with the second PET film 32, pores are not formed in the surface of the liquid silicone rubber 22 during the foaming procedure.

In other words, in conventional manufacturing processes, pores are inevitably formed in the surface of the liquid silicone rubber as a result of the foaming procedure. In contrast to this, according to the present invention, since the second PET film 32 remains in contact with the surface of the liquid silicone rubber 22, where bubbles occur in the surface of the liquid silicone rubber, the bubbles grow downwards due to the second PET film 32 blocking them. Consequently, the resulting liquid silicone rubber 22 does not contain pores, that is, traces of the bubbles, in the surface.

As such, where the liquid silicone rubber foam does not contain pores in the surface thereof, it can exhibit an excellent cushion property and a sealing capability.

As the combined structure of the first PET film 12, the liquid silicone rubber 22 and the second PET film 32, as illustrated in FIG. 6, is foamed and cured through the foaming and curing unit 50 and is then discharged therefrom, the second PET film 32, namely, a release sheet, is recovered in the second PET film-recovering unit 40 while the liquid silicone rubber foam G, which is the final product, is taken up on the liquid silicone rubber foam-take-up unit 60.

The liquid silicone rubber foam-take-up unit 60 is intended to take up the liquid silicone rubber foam G, from which the second PET film 32 has been recovered in the second PET film-recovering unit 40, using a take-up roller 61, which completes the process of manufacturing the product. According to the present invention, with the aid of the take-up roller 61 of the liquid silicone rubber foam-take-up unit 60, the liquid silicone rubber foam G can be continuously manufactured in a roll form, thus enabling mass production.

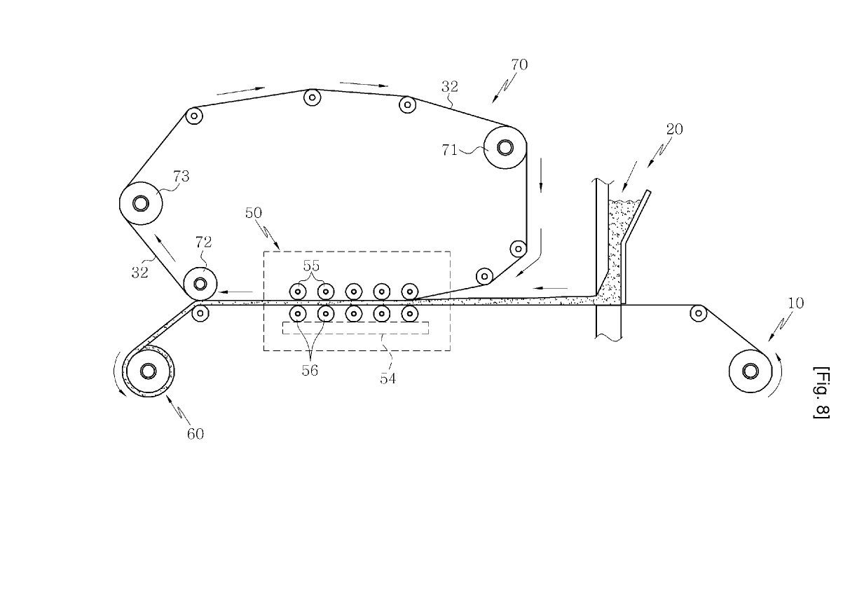

FIG. 7 is a schematic view showing an apparatus for manufacturing a roll-type liquid silicone rubber foam according to a second embodiment of the present invention.

As shown in the drawing, the apparatus for manufacturing a roll-type liquid silicone rubber foam according to the second embodiment of the present invention is substantially the same as that of the first embodiment of the present invention, except that the second PET film-supplying unit 30 and the second PET film-recovering unit 40 in the first embodiment are replaced with a second film-circulating unit 70.

More specifically, the second PET film-circulating unit 70 is designed to cause the second PET film 32 to be infinitely circulated through the foaming and curing unit 50 with the aid of a plurality of rollers.

The plurality of rollers is comprised of first to third main rollers 71 to 73 and a plurality of auxiliary rollers. The design of the second PET film-circulating unit 70 may be modified in any fashion, if desired.

As a whole, the apparatus for manufacturing a roll-type liquid silicone rubber foam according to the second embodiment of the present invention comprises:

The operation of the second embodiment of the present invention, which incorporates the second PET film-circulating unit 70 therein, is substantially the same as that of the first embodiment of the present invention, and thus the detailed description thereof is omitted herein.

FIG. 8 is a schematic view showing an apparatus for manufacturing a roll-type liquid silicone rubber foam according to a third embodiment of the present invention.

As shown in the drawing, the apparatus for manufacturing a roll-type liquid silicone rubber foam according to the third embodiment of the present invention is substantially the same as that of the second embodiment of the present invention, except for the internal construction of the foaming and curing unit 50 of the second embodiment of the present invention.

More specifically, in the foaming and curing unit 50 according to the third embodiment of the present invention, the plurality of thickness-controlling and pressing bars 52 in the second embodiment, which is installed in an inner and upper position in the foaming and curing chamber 51, is replaced with a plurality of upper thickness-controlling and pressing rollers 55, the respective rollers 55 being spaced apart from each other at predetermined intervals, and the plurality of support bars 53 in the second embodiment is replaced with a plurality of lower support rollers 56.

The operation and functions of the foaming and curing unit 50 in this embodiment are substantially the same as those of the first and second embodiments.

1. An apparatus for manufacturing a liquid silicone rubber foam, comprising:
a first PET film-supplying unit, adapted to supply a first PET film having a predetermined width;
a liquid silicone rubber-supplying unit, adapted to apply a liquid silicone rubber, containing a foaming agent and a curing agent, on a surface of the PET film, which is supplied from the first PET film-supplying unit;
a second PET film-supplying unit, adapted to supply a second PET film having no stickiness on the liquid silicone rubber applied to the first PET film which is transferred from the first PET film-supplying unit through the liquid silicone rubber-supplying unit;
a second PET film-recovering unit, adapted to recover the second PET film transferred from the second PET film-supplying unit;
a foaming and curing unit, positioned between the second PET film-supplying unit and the second PET film-recovering unit and adapted to foam and cure the liquid silicone rubber disposed between the first PET film and the second PET film and to control a thickness of the liquid silicone rubber which is being foamed; and
a liquid silicone rubber foam-take-up unit, adapted to take up the liquid silicone rubber foam, as a final product, in a form of a roll, which is transferred from the foaming and curing unit during the recovering the second PET film into the second PET film-recovering unit.

2. The apparatus for manufacturing a liquid silicone rubber foam, according to claim 1, wherein the first PET film-supplying unit includes a supply roller on which the first PET film, having a predetermined width, is wound.

3. The apparatus for manufacturing a liquid silicone rubber foam, according to claim 1, wherein the liquid silicone rubber-supplying unit comprises:
a guide part, into which the liquid silicone rubber is introduced;
a feed rate-controlling part, to allow the liquid silicone rubber introduced through the guide part to be distributed to the first PET film at a predetermined feed rate; and
a base part installed opposite the feed rate-controlling part.

4. The apparatus for manufacturing a liquid silicone rubber foam, according to claim 3, wherein the feed rate-controlling part is vertically displaceable, and is provided at a lower end thereof with an inclined surface.

5. The apparatus for manufacturing a liquid silicone rubber foam, according to claim 1, wherein the second PET film-supplying unit includes a supply roller, on which the second PET film, which is a release film having no stickiness and having the same width as that of the first PET film, is wound.

6. The apparatus for manufacturing a liquid silicone rubber foam, according to claim 1, wherein the second PET film-recovering unit includes a recovery roller, which is adapted to take up and thus recover the second PET film, passed through the foaming and curing unit.

7. The apparatus for manufacturing a liquid silicone rubber foam, according to claim 1, wherein the foaming and curing unit comprises:
a foaming and curing chamber, which has a case shape;
a plurality of thickness-controlling and pressing bars, disposed in the foaming and curing chamber, which is positioned over the second PET film and are vertically displaceable so as to control the thickness of the liquid silicone rubber disposed between the first PET film and the second PET film, and in which the plurality of thickness-controlling and pressing bars are positioned at predetermined intervals;
a plurality of support bars, which are positioned under the first PET film and are aligned with the thickness-controlling and pressing bars; and
a heater part, which is installed in the foaming and curing chamber to promote foaming and curing of the liquid silicone rubber.

8. The apparatus for manufacturing a liquid silicone rubber foam, according to claim 7, wherein each of the plurality of thickness-controlling and pressing parts is provided at lower end with an inclined surface having a predetermined angle.

9. The apparatus for manufacturing a liquid silicone rubber foam, according to claim 1, wherein each of the first and second PET films has a width of 300 mm-1,000 mm.

10. An apparatus for manufacturing a liquid silicone rubber foam, comprising:
a first PET film-supplying unit adapted to supply a first PET film having a predetermined width;
a liquid silicone rubber-supplying unit adapted to apply a liquid silicone rubber, containing a foaming agent and a curing agent, on a surface of the PET film, which is supplied from the first PET film-supplying unit;
a second PET film-circulating unit, adapted to supply a second PET film having no stickiness on the liquid silicone rubber applied to the first PET film, which is supplied from the first PET film-supplying unit through the liquid silicone rubber-supplying unit, and adapted to circulate the second PET film through a foaming and curing unit and a plurality of rollers;
a foaming and curing unit, adapted to foam and cure the liquid silicone rubber disposed between the first PET film and the second PET film and to control a thickness of the liquid silicone rubber; and
a liquid silicone rubber foam-take-up unit, adapted to take up the liquid silicone rubber foam, as a final product, into a form of a roll, which is transferred from the foaming and curing unit during the circulating the second PET film.

11. The apparatus for manufacturing a liquid silicone rubber foam, according to claim 10, wherein the plurality of rollers includes first to third main rollers and a plurality of auxiliary rollers.

12. The apparatus for manufacturing a liquid silicone rubber foam, according to claim 10, wherein the foaming and curing unit comprises:
a foaming and curing chamber, which has a case shape;
a plurality of thickness-controlling and pressing rollers disposed in the foaming and curing chamber, which is positioned over the second PET film and is vertically displaceable so as to control the thickness of the liquid silicone rubber disposed between the first PET film and the second PET film, and in which the plurality of thickness-controlling and pressing bars rollers is positioned at predetermined intervals;
a plurality of support rollers, which is positioned under the first PET film and is aligned with the thickness-controlling and pressing rollers; and
a heater part, which is installed in the foaming and curing chamber to promote the foaming and curing the liquid silicone rubber.
